(19) United States
(12) Patent Application Publication
(10) Pub. No.: US 2007/0081339 A1
(43) Pub. Date: Apr. 12, 2007

(54) LED light source module with high efficiency heat dissipation

(76) Inventors: Huai-Ku Chung, HsinChu (TW); Cheng-Wei Yang, HsinChu (TW); Chien-Hung Lin, HsinChu (TW); Shun-Lih Tu, HsinChu (TW); Hung-Tung Wang, HsinChu (TW)

Correspondence Address: LIN & ASSOCIATES INTELLECTUAL PROPERTY, P.O. BOX 2339, SARATOGA, CA, 95070-0339, US

(21) Appl. No.: 11/246,877

(22) Filed: Oct. 7, 2005

(51) Int. Cl. F21V 29/00

(52) U.S. Cl. 362/294; 362/373

(57) ABSTRACT

The present invention provides an LED light source module design featured with efficient heat dissipation. This invention comprises a printed circuit board of thickness less than 400 μm, installed with an LED array which is composed of multiple high powers, super bright emitter LEDs. The thinner version of the printed circuit provides shorter route for faster thermal conductivity; and thus promotes the efficiency for heat dissipation. With its bendable flexibility, the thinner version of the printed circuit board can accommodate and well affix to the inner side of any shape of lighting fixture rack. This further enhances the heat dissipation for varieties of lighting fixture rack design.

### FIELD OF THE INVENTION

The present invention generally relates to a light emitting diode (LED) light source module, and more specifically to a high power, super bright LED light source module and its application lighting fixtures featured with high efficiency heat dissipation.

### BACKGROUND OF THE INVENTION

The historic use of light emitting diode (LED) sourced back to the 60's in the last millennium, when people used LEDs for indication of radio on/off states. In recent years, LEDs have been widely used in almost all aspects of daily lives, such as traffic lights, automobile rear lights, monitor screen displays, etc. Compared with the conventional incandescent bulbs, LED light source offers the advantages of low power consumption and being flicker free. Most amazingly, the life time of an LED light source can be as long as a couple of ten years. Instead of the fragile, high temperature, and short life filament, LEDs use durable semiconductors for electrical current transmission. To efficiently use LEDs for general light source, however, there is one major technical barrier needs to be resolved. Brighter LED light sources need higher power LEDs and also generate much more heat. Taking the LED arrays used for street lighting as an example, without an efficient heat dissipation facility, the resulting high heat will greatly reduce the life spend of the LED arrays and even affect the overall reliability of the whole equipment.

Referring to FIG. 1, a conventional LED street light 10. The printed circuit board used 1 is either a generic FR4 type or a heat dissipating type with thermal conductive metals such as aluminum or copper. From a visual art designer's point of view, it is very common to shape a street lighting fixture rack 4 with a non-planar geometric curved or wavy design. The mass heat generated from the high power LED street light 10 not only dramatically reduces the life spend of the LED lighting fixture but also affects the illumination quality, efficiency and reliability of the whole equipment. That's why in the design for a conventional LED street light 10, there is a need to add an extra planer metal base 3, which serves as a cushion between the printed circuit board 1 and the lighting fixture rack 4, to enhance the heat dissipation effect by assuring the intimate contact of both printed circuit board 1 and the lighting fixture rack 4. The mass heat generated by the LED array 2 on the printed circuit board 1, through the aid of the buffering metal base 3, can thus be efficiently conducted to the lighting fixture rack 4, and further be dissipated to the surrounding atmosphere. Even so, with the conventional design, the heat dissipation efficiency for the mass heat from the LED array 2 on the printed circuit board 1 is still far from satisfaction.

### SUMMARY OF THE INVENTION

The present invention provides a high efficiency heat dissipation LED light source module, wherein the thickness of the printed circuit board is less than 400 μm, preferably less than 200 μm. The design of the invention can be easily applied to lighting equipments with varieties of non-planer geometric designs of lighting fixture racks. With the bendable flexibility, the thin printed circuit board can easily accommodate and tightly affix to a non-planar lighting fixture rack. The whole lighting fixture rack can thus serve as a direct heat sink; this achieves the high efficiency heat resistant effect by dissipating the heat into the surrounding atmosphere through the large dissipation area on the lighting fixture rack. The fabrication of this thinner printed circuit board is a standard technology; there is no major modification to the existing manufacturing cost, equipments, and fabrication processes. In addition to the advantage of better fitting into various shapes of lighting fixture racks with the bendable flexibility, this thinner version of printed circuit board with its thickness less than 400 μm, preferably less than 200 μm, also enhances the heat dissipation effect through faster and thus improved heat conductivity.

To accomplish said both advantages, the present invention provides a high efficiency heat dissipation LED light source module, which comprises a printed circuit board with its thickness less than 400 μm; one LED array, which is composed of multiple high power, super bright emitter LEDs, and is installed on said printed circuit board. Each said emitter LED connects to the electrical conductivity layer of the printed circuit board with a transmission line.

With the present invention for a high efficiency heat dissipation LED light source module, a lighting equipment can be designed as follows: one lighting fixture rack; one printed circuit board, which is tightly attached to the inner layer of the lighting fixture rack, with its thickness less than 400 μm, with bendable flexibility; one LED array, as light source, installed on said printed circuit board, and connects to the electrical conductivity layer of the printed circuit board with a transmission line; one light cover which tightly affixes to the lighting fixture rack; wherein, the back side of the printed circuit board without the LED array, also affixes to the inner surface of the lighting fixture rack.

With the present invention, the thickness of said printed circuit board is less than 400 μm, preferably less than 200 μm. The design of the invention can be easily applied to lighting equipments with varieties of non-planer geometric designs of lighting fixture racks. With the bendable flexibility, the thin printed circuit board can easily accommodate and tightly affix to any non-planar lighting fixture rack. The whole lighting fixture rack can serve directly as a heat sink, thus achieves the highly efficient heat dissipation without the need for an extra planer metal heat dissipation base as was used in a conventional LED lighting design. Additionally, with the present invention, the thinner version of printed circuit board with thickness less than 400 μm, preferably less than 200 μm, also provides shorter route for heat conductivity, thus promotes the efficiency for heat dissipation onto the lighting fixture rack. In addition to the much improved heat dissipation efficiency, the lighting fixture designed with said highly efficient heat resistant LED light source module also advantages itself with not only lower cost but also with much compact fixture design.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a side-elevational cross-sectional view of a conventional street light using LEDs as light source.

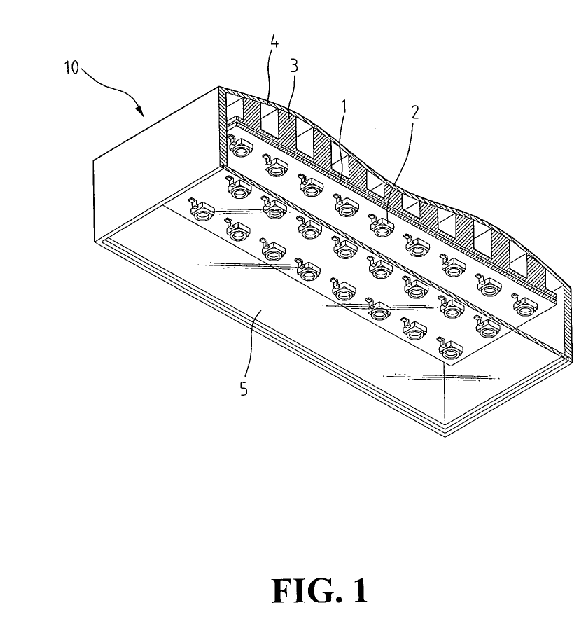

FIG. 2 shows a 3-D perspective view of the present invention.

FIG. 3 shows a cross-sectional view of the present invention.

FIG. 4 shows a side-elevational cross-sectional view of a first embodiment according to the present invention.

### DETAILED DESCRIPTION OF THE PREFERRED EMBODIMENTS

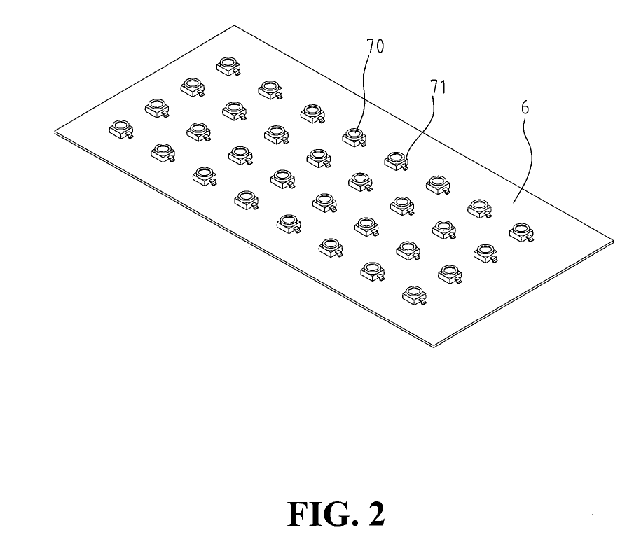

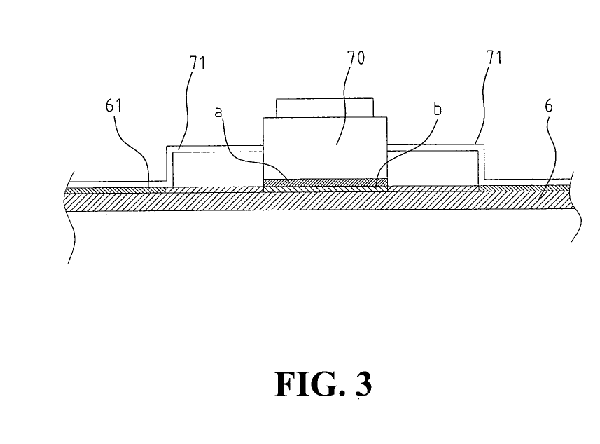

FIG. 2 and FIG. 3 illustrate a 3-D perspective view and a cross-sectional view of the present invention for an efficient heat resistant LED light source module, respectively. The present invention comprises one printed circuit board 6 and an LED array composing of multiple emitter LEDs 70. The thickness of the printed circuit board 6 is less than 400 μm, preferably less than 200 μm, which features itself with bendable flexibility. Each emitter LED is high powered and super bright, installed on said printed circuit board 6, and connects to the electrical conductivity layer of the printed circuit board 6 with transmission wire 71. Depending on the diversity of applications, the LED array layout pattern, number of LEDs for the array and the color of the LED light source, etc. can vary to achieve the desired need for color, brightness and chromaticity.

Referring to FIG. 3, to enhance the effect of heat dissipation for each emitter LED 70, there is a thermal conductive layer a formed between each said emitter LED and the printed circuit board 6. The material used for thermal conductive layer a can be thermal paste, thermal plate, or any other media of material and method which can efficiently transmit the heat generated from each said LED 70 onto the printed circuit board 6.

On the printed circuit board 6, there are metal patches b for setting each said emitter LED 70. The material of the metal patches b can be gold or copper, etc. Wherein, each metal patch b is for heat dissipation, and is different from the electrical metal circuitry 61 on the printed circuit board 6, which are for the electrical transmission. Metal patches b and metal circuitry 61 on the printed circuit board 6 are not connected to one another. The heats generated from each emitter LED 70 can be effectively dissipated by the thermal conductive layer a, plus the metal patch b onto the printed circuit board 6. With the present invention of said thin version of printed circuit board 6, the heat on said printed circuit board can be effectively conducted onto the other side of the printed circuit board, and thus enhances the overall heat dissipation effect. The overall heat dissipation effect for the whole unit can be further improved with more complementary thermal conductive parts, (such as on the lighting fixture rack, which will be described in the later section). The thinner version of said printed circuit board 6 also provides itself with the advantage of bendable flexibility for any non-planar geometric design of fixture rack with the LED lighting modules; this extends the horizon of the application varieties of the present invention.

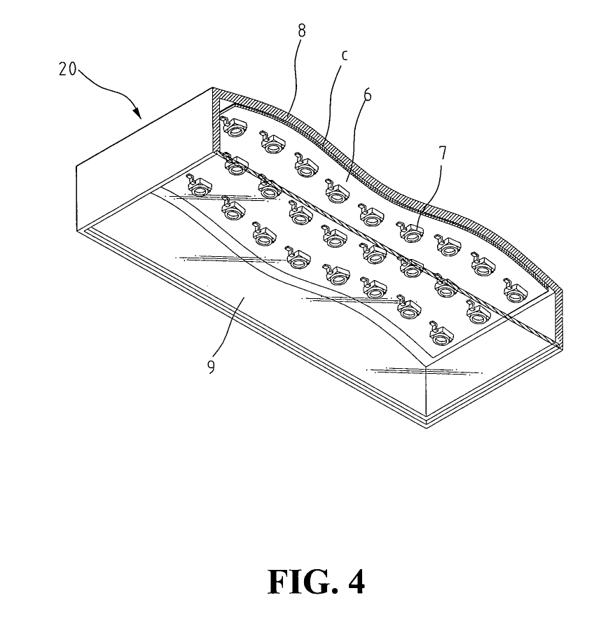

FIG. 4 shows a side-elevational view of an LED street light design according to the present invention. The LED street light 20 comprises an LED array 7, which is composed of multiple emitter LEDs arranged as an array, and installed on the printed circuit board 6. With transmission wire, each emitter LED connects to the electro conductivity layer of said printed circuit board 6. Wherein, the thickness of the printed circuit board 6 is less than 400 μm, preferably less than 200 μm. The thin version of the printed circuit board 6 offers itself with bendable flexibility. Depending upon the design of the light cover 9 and the need for uniform illumination, the arrangement of the LED array 7 can vary accordingly. For example, by grouping the same color of LEDs into a serious line of array, three lines of LED arrays, with colors of red (R), green (G), and blue (B), respectively, and connected in parallel, can form a matrix of LED light source. The circuitry constituted by the LED matrix can be controlled by a micro processing unit (MPU). With the pulse width modulation (PWM) at the high frequency of over 1000 pulses per second, the brightness for each set of LED array can be well controlled to achieve the desired composite effect of chromaticity. The whole printed circuit board 6 along with the LED arrays 7 is affixed to the inner side of the lighting fixture rack 8. With the bendable flexibility, the back side of the printed circuit board 6 without the LED array can fit tightly onto the inner side of the non-planar lighting fixture rack 8. In this embodiment, the lighting fixture rack is in wavy shape. The shape of the lighting fixture rack can also be in curvature. Since the back of the thinner printed circuit board 6 is flexible enough to tightly affix to the inner side of the lighting fixture rack 8, the lighting fixture rack 8 also serves as a perfect direct heat sink for the whole unit. Material with efficient thermal conductivity, metals such as aluminum, copper, etc., are all good candidates for the lighting fixture rack. Between the printed circuit board 6 and the lighting fixture rack 8, there is a complimentary thermal cushion layer c to ensure perfect contact and enhanced heat dissipation. The thermal cushion layer c can be made of thermal paste, thermal plate, or any other media and methods which can serve the need for efficiently dissipating the heat from the printed circuit board to the lighting fixture rack. Finally, the LED lighting fixture can be finished with a transparent light cover 9, which is tightly affixed to the lighting fixture rack.

The bendable flexibility of the thinner version of the printed circuit board 6 with the present invention advantages itself for easily affixing to the inner side of said lighting rack 8. This facilitates the lighting fixture rack 8 as a direct heat sink by expanding heat dissipation. Additionally, the thinner version of the printed circuit with the present invention, with thickness less than 400 μm, preferably less than 200 μm, enhances the thermal conductivity, and further promotes the overall heat dissipation effect of the whole unit of lighting fixture.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light emitting diode (LED) light source module featured with efficient heat dissipation, comprising:
a printed circuit board of thickness less than 400 μm; and
an LED array composed of multiple high power and super bright emitter LEDs, installed on said printed circuit board, and connected to the electrical circuitry layer of the printed circuit board with transmission wires.

2. The LED light source module featured with efficient heat dissipation as claimed in claim 1, wherein said printed circuit board is featured with bendable flexibility.

3. The LED light source module featured with efficient heat dissipation as claimed in claim 1, wherein the thickness of said bendable printed circuit board is less than 200 μm.

4. The LED light source module featured with efficient heat dissipation as claimed in claim 1, wherein there is a high thermal conductive layer filled in the gap between said bendable printed circuit board and said emitter LEDs.

5. The LED light source module featured with efficient heat dissipation as claimed in claim 1, wherein there are multiple metal patches distributed on said bendable printed circuit board, and each said metal patch locates on a said emitter LED.

6. A lighting fixture using the LED light source module featured with efficient heat dissipation, comprising:
a lighting fixture rack; and
a printed circuit board, with the thickness less than 400 μm, installed and affixed to the inner side of said lighting fixture rack; an LED array as the light source installed on said printed circuit board, and connected to the electrical circuitry of said printed circuit board with transmission wires; and
a light cover, tightly attached to the lighting fixture rack, wherein the back side of said printed circuit board with no LED array is also affixed to the inner side of said lighting fixture rack.

7. The lighting fixture using the LED light source module featured with efficient heat dissipation as claimed in claim 6, wherein the thickness of said printed circuit board is less than 200 μm.

8. The lighting fixture using the LED light source module featured with efficient heat dissipation as claimed in claim 6, wherein there is a high thermal conductive layer between the lighting fixture rack and the back side of said printed circuit board without LED array.

9. The lighting fixture using the LED light source module featured with efficient heat dissipation as claimed in claim 6, wherein the inner side of said lighting fixture rack is in shape of irregular non-planar curvature.

10. The lighting fixture using the LED light source module featured with efficient heat dissipation as claimed in claim 6, wherein, the inner side of said lighting fixture rack is wavy.

11. The lighting fixture using the LED light source module featured with efficient heat dissipation as claimed in claim 6, wherein said lighting fixture rack is made of metal or any material with high thermal conductivity.

12. The lighting fixture using the LED light source module featured with efficient heat dissipation as claimed in claim 6, wherein said lighting fixture rack is made of aluminum.

13. The lighting fixture using the LED light source module featured with efficient heat dissipation as claimed in claim 6, wherein, said lighting fixture rack is made of copper.

14. The lighting fixture using the LED light source module featured with efficient heat dissipation as claimed in claim 6, wherein said lighting fixture is an LED light source for street lighting.
